(19) United States
(12) Patent Application Publication
(10) Pub. No.: US 2022/0152676 A1
(43) Pub. Date: May 19, 2022

(54) Buckling-Assisted Manufacturing of Microscopic Metallic Tubes and Related Devices

(71) Applicant: Texas Tech University System, Lubbock, TX (US)

(72) Inventors: Chandra Sekhar Meduri, Lubbock, TX (US); Zhonglue Hu, Lubbock, TX (US); Golden Kumar, Lubbock, TX (US); Jerzy Blawzdziewicz, Lubbock, TX (US); Harvinder Singh Gill, Lubbock, TX (US)

(21) Appl. No.: 17/439,042

(22) PCT Filed: Mar. 18, 2020
(86) PCT No.: PCT/US2020/023455

§ 371 Date: Sep. 14, 2021

Related U.S. Application Data
(60) Provisional application No. 62/820,216, filed on Mar. 18, 2019.

(51) Int. Cl. B21C 1/22; B21C 9/00

(52) U.S. Cl. CPC B21C 1/22; B21C 9/00

(57) ABSTRACT

Embossing of metallic glass supercooled liquids into templates is emerging as a precision net-shaping and surface patterning technique for metals. Here, the effect of thickness of metallic glass on template-based embossing is disclosed. The results show that the existing embossing theory developed for thick samples fails to describe the process when the thickness of metallic glass becomes comparable to the template cavity diameter. Increased flow resistance at the cavity entrance results in viscous buckling of supercooled liquid instead of filling. A new phenomenological equation is proposed to describe the thickness dependent filling of template cavities. The buckling phenomenon is analyzed based on the folding model of multilayer viscous media. Controlled buckling can be harnessed in fabrication of metal microtubes, which are desirable for many emerging applications.

### CROSS-REFERENCE TO RELATED APPLICATIONS

This application claims priority to and is a PCT patent application of U.S. provisional patent application Ser. No. 62/820,216 filed on Mar. 18, 2019 and entitled “Buckling-Assisted Manufacturing of Microscopic Metallic Tubes and Related Devices”, which is hereby incorporated by reference in its entirety.

### STATEMENT OF FEDERALLY FUNDED RESEARCH

This invention was made with government support under CMMI-1663568 and CMMI-1653938 awarded by the National Science Foundation. The government has certain rights in the invention.

### TECHNICAL FIELD OF THE INVENTION

The present invention relates in general to the field of microscopic manufacturing processes.

### BACKGROUND OF THE INVENTION

Without limiting the scope of the invention, its background is described in connection with microscopic metallic tubes.

Fabrication of open-ended metallic (amorphous and crystalline) micro- and nano-tubes has been challenging due to need of complex and expensive processing steps. The two main strategies in use are deposition-based approach for crystalline metals and hot-drawing approach for amorphous metals (metallic glasses). Both approaches require expensive sacrificial templates fabricated by lithographic techniques. The crystalline metals are deposited on templates using electroplating, chemical-vapor-deposition (CVD), or physical-vapor-deposition (PVD). Subsequently, the templates are dissolved to produce hollow metal structures. The major drawbacks are (i) use of expensive disposable templates, (ii) only limited compositions can be deposited, and (iii) special pre-plating procedures are required. While some of these limitations can be overcome by using hot-drawing of amorphous metals, the need for disposable templates cannot be avoided. Moreover, the amorphous metal hollow structures produced by hot-drawing are not through accessible, making them unsuitable for transport applications.

### SUMMARY OF THE INVENTION

A method for manufacturing microscopic metallic (amorphous and crystalline) tubes using buckles as seed structures in pulling of metallic liquids is disclosed. The procedure enables fabrication of tubes with any combinations of porosity, length, wall thickness, and tapering angle. The structures themselves are self-standing, and the devices thus fabricated can be used as microneedles in drug delivery devices, heat exchangers in microelectronics, through channels in microfluidic devices, and electrodes in sensors.

In one embodiment, the process uses viscous buckles of controllable dimensions as seed structures in metallic liquids. Micro and nano-scale tubes are fabricated using inexpensive templates (made by drilling) by mechanically downsizing the tube opening during elongation. The procedure always forms self-standing tubes that are attachable to any substrate (a desirable feature in micro-devices) without requiring any post-processing procedures. The process removes the complex template-making and template-removal steps, which greatly reduces the production cost and time.

In another embodiment, a method for manufacturing a hollow metallic structure comprises: hot-pressing an amorphous metal into a cavity of a template until a buckle is formed, wherein a thickness of the amorphous metal is less than or equal to a diameter of the cavity; and forming the hollow metallic structure by pulling the amorphous metal away from the template.

In one aspect, the method further comprises providing a first plate, the template disposed on the first plate, and a second plate disposed above the template and substantially parallel to the first plate. In another aspect, the first plate comprises a first heating plate, the second plate comprises a second heating plate, and the amorphous metal is heated above a glass transition temperature of the amorphous metal using the first and second heating plates. In another aspect, the method further comprises depositing the amorphous metal on a top of the template over the cavity. In another aspect, the hollow metallic structure is self-standing. In another aspect, the method further comprises forming a metallic tube by cooling and fracturing the hollow metallic structure. In another aspect, the method further comprises using the metallic tube as a needle, and heat exchanger, a through channel or an electrode. In another aspect, the method further comprises attaching the metallic tube to a substrate. In another aspect, the method further comprises crystallizing the hollow metallic structure. In another aspect, the method further comprises controlling a lateral dimension of the buckle via a thickness of the amorphous metal, a diameter of the cavity and a temperature. In another aspect, the method further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature. In another aspect, the cavity comprises two or more cavities and the hollow metallic structure is formed from each cavity. In another aspect, the two or more cavities are arranged in a pattern or an array.

In another embodiment, a hollow metallic structure is manufactured by a process comprising: hot-pressing an amorphous metal into a cavity of a template until a buckle is formed, wherein a thickness of the amorphous metal is less than or equal to a diameter of the cavity; and forming the hollow metallic structure by pulling the amorphous metal away from the template.

In one aspect, the process further comprises providing a first plate, the template disposed on the first plate, and a second plate disposed above the template and substantially parallel to the first plate. In another aspect, the first plate comprises a first heating plate, the second plate comprises a second heating plate, and the amorphous metal is heated above a glass transition temperature of the amorphous metal using the first and second heating plates. In another aspect, the process further comprises depositing the amorphous metal on a top of the template over the cavity. In another aspect, the hollow metallic structure is self-standing. In another aspect, the process further comprises forming a metallic tube by cooling and fracturing the hollow metallic structure. In another aspect, the process further comprises using the metallic tube as a needle, and heat exchanger, a through channel or an electrode. In another aspect, the process further comprises attaching the metallic tube to a substrate. In another aspect, the process further comprises crystallizing the hollow metallic structure. In another aspect, the process further comprises controlling a lateral dimension of the buckle via the thickness of the amorphous metal, the diameter of the cavity and a temperature. In another aspect, the process further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature. In another aspect, the cavity comprises two or more cavities and the hollow metallic structure is formed from each cavity. In another aspect, the two or more cavities are arranged in a pattern or an array.

In another embodiment, a method for manufacturing a hollow metallic structure comprises: providing a first heating plate, a template disposed on the first heating plate, a second heating plate disposed above the template and substantially parallel to the first heating plate, and a cavity formed in a top of the template; depositing an amorphous metal on the top of the template over the cavity; hot-pressing the amorphous metal into the cavity of the template using the first heating plate and the second heating plate until a buckle is formed, wherein a thickness of the amorphous metal is less than or equal to a diameter of the cavity and the amorphous metal is heated above a glass transition temperature of the amorphous metal; and forming the hollow metallic structure by pulling the amorphous metal away from the template.

In one aspect, the hollow metallic structure is self-standing. In another aspect, the method further comprises forming a metallic tube by cooling and fracturing the hollow metallic structure. In another aspect, the method further comprises using the metallic tube as a needle, and heat exchanger, a through channel or an electrode. In another aspect, the method further comprises comprising crystallizing the hollow metallic structure. In another aspect, the method further comprises controlling a lateral dimension of the buckle via a thickness of the amorphous metal, a diameter of the cavity and a temperature. In another aspect, the method further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature. In another aspect, the cavity comprises two or more cavities and the hollow metallic structure is formed from each cavity. In another aspect, the two or more cavities are arranged in a pattern or an array.

### BRIEF DESCRIPTION OF THE DRAWINGS

For a more complete understanding of the features and advantages of the present invention, reference is now made to the detailed description of the invention along with the accompanying figures and in which:

FIGS. 1A-1I depict thermoplastic embossing of Pt-based metallic glass with varying thicknesses against a cylindrical cavity of diameter 200 μm and scanning electron microscope (SEM) images of the embossed pillars and the top surfaces;

FIG. 2 is an illustration of experimental procedure used to study the effects of metallic glass thickness, template cavity diameter, and loading on embossing in accordance with one embodiment of the present invention;

FIG. 3 illustrates the effect of metallic glass thickness on normalized filling length (L̅), which compares measured values (red squares), the existing theory (Eq. (1)), and the proposed model (Eq. (3)) in accordance with one embodiment of the present invention;

FIG. 4 illustrates the normalized final thickness (H/D) as a function of maximum applied pressure in accordance with one embodiment of the present invention;

FIGS. 5A and 5B are schematic cross-sectional views of buckle formation with a wavelength (λ) in accordance with one embodiment of the present invention;

FIG. 5C is a schematic cross-sectional view of the fabrication of a hollow metallic structure by elongation of buckle in accordance with one embodiment of the present invention;

FIG. 5D is a SEM image of Pt-based metallic glass microtube produced by buckling and elongation in accordance with one embodiment of the present invention;

FIGS. 6A-6D depict an overview of fabrication technique and examples of metallic glass microtubes (individual and arrays) achieved in accordance with one embodiment of the present invention;

FIGS. 7A-7D show SEM images of representative samples fabricated in accordance with one embodiment of the present invention;

FIGS. 8A-8C are high magnification optical images demonstrating the flow of water (indicated by the red arrows) in the metallic glass microtube after it was mechanically attached to a fluidic device equipped with flow in accordance with one embodiment of the present invention;

FIG. 9 is a schematic of thermoplastic embossing showing velocity profiles of metallic glass flow in accordance with one embodiment of the present invention;

FIG. 10 is a flow chart of a method for manufacturing a hollow metallic structure in accordance with another embodiment of the present invention; and

FIG. 11 is a flow chart of a method for manufacturing a hollow metallic structure in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the invention, except as outlined in the claims.

The supercooled liquid state of metallic glasses has been utilized in a wide range of thermoplastic forming operations such as, embossing [1-3], blow molding [4, 5], extrusion [6], rolling [7, 8], and drawing [9, 10]. Parallel-plate embossing has gained increasing attention due to its ability to produce nanoscale structures using a simple hardware [11, 12]. In embossing, a sheet of metallic glass is pressed onto a rigid template using two parallel plates heated above the glass transition temperature (T_{g}) of the metallic glass [1, 2, 13]. Above T_{g}, the metallic glass becomes a metastable supercooled liquid, which can fill the template features under pressure. Thermoplastic embossing of metallic glasses is typically carried out in air using standard compression testing machines equipped with heating provision [1, 2, 13]. The technique has been used to fabricate precise 3D microparts [1], controllable nanostructures [14], and hierarchically textured surfaces [9] from various metallic glass formers.

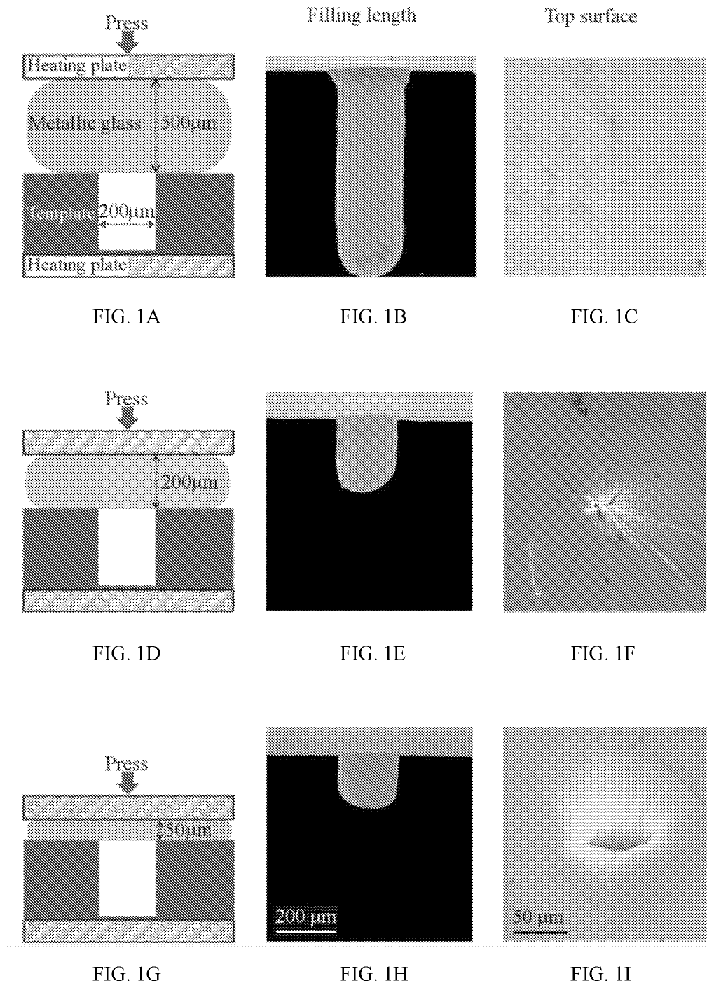

The filling of template cavities during embossing has been described by assuming Newtonian behavior of metallic glass supercooled liquids and creeping flow conditions [1, 15-18]. The earlier studies proposed a modified Hagen-Poiseuille equation¹ to predict the template filling as a function of embossing parameters and supercooled liquid properties. Neglecting the capillary pressure and the oxidation related terms, the embossing pressure for a cylindrical cavity can be expressed as

$$P \approx \frac{32 η}{t} {( \frac{L}{D} )}^{2} \qquad ( 1 )$$

where P is the embossing pressure at the entrance of the cavity, L is the filling length, D is the cavity diameter, η is the viscosity of supercooled liquid, and t is the embossing time. The pressure dependence on L (or L/D ratio) suggests that the viscous resistance at the cavity entrance was neglected (i.e. infinite supply of metallic glass was assumed), and only the flow resistance along the length of the cavity was considered. The equation yielded good agreement because the typical thicknesses (>500 μm) of metallic glass used in experiments is larger than the lithographic template features (D<100 μm). However, as demonstrated below, Eq. (1) does not accurately describe the template filling when the thickness of metallic glass becomes comparable or smaller than the cavity diameter. FIGS. 1A-1I show an example of Pt_{57.5}Cu_{14.7}Ni_{5.3}P_{22.5} (Pt-based) metallic glass of varying initial thicknesses (2.5D, D, 0.25D) thermoplastically embossed onto a cylindrical cavity under the same conditions.

More specifically, FIGS. 1A, 1D and 1G illustrate the thermoplastic embossing of Pt-based metallic glass with varying thicknesses (500 μm, 200 μm and 50 μm respectively) against a cylindrical cavity of diameter 200 μm. FIGS. 1B, 1E and 1H are scanning electron microscope (SEM) images of the embossed pillars corresponding to 1A, 1D and 1G, respectively. The filling length is shorter in thin samples. In addition, the filling length is in good agreement with Eq. (1) for the thick sample (2.5D) but deviates significantly for the thin samples (D, 0.25D). FIGS. 1C, 1F and 1I are SEM images of the top surface the metallic glass showing the significant effect of thickness on the embossing process corresponding to 1A, 1D and 1G, respectively. The top surfaces of the thinner samples show formation of wrinkles and hollow indents (buckles). The surface instabilities form when the thickness approaches cavity diameter during embossing. Buckles are not observed in FIGS. 1A-1C when the metallic glass thickness was greater than the cavity diameter. Similar effects have been observed in thermoplastic embossing of thin polymer films [19-21]. With increasing interest in metallic glass thin films [22-24], it is important to investigate the effect of thickness on embossing. In addition, controlled buckling can lead to interesting applications in micro/nanofabrication [25, 26]. The effect of metallic glass thickness on the filling length (L) and buckle formation during thermoplastic embossing can be understood based on this disclosure. Pt-based metallic glass is used as a model material because of its oxidation resistance and superior thermoplastic formability [1, 9, 16]. The details about the synthesis of Pt-based metallic glass have been reported elsewhere [1].

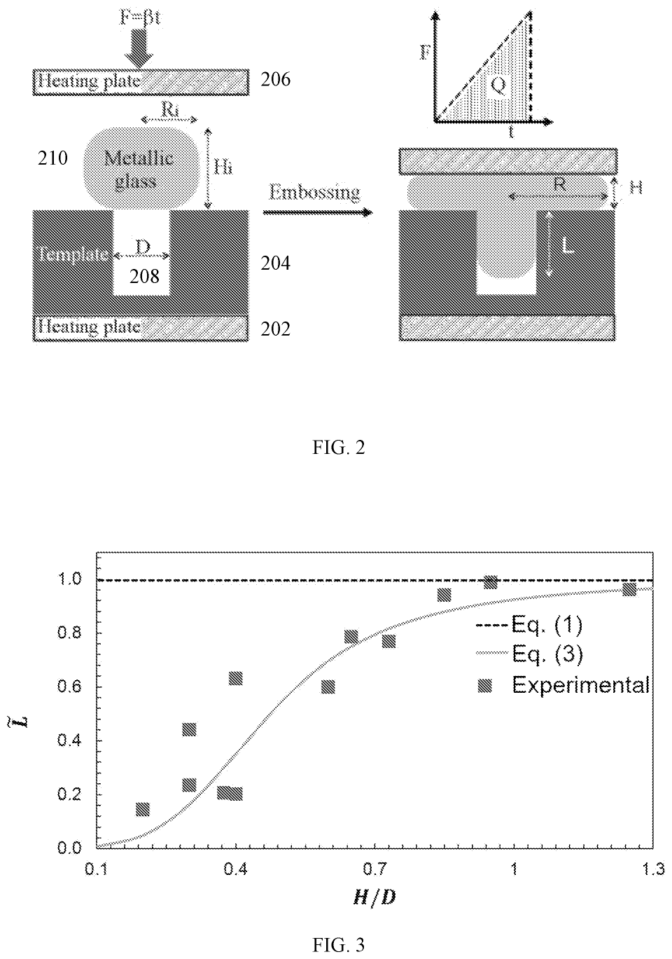

A schematic of the cross-sectional view of thermoplastic embossing used in the present study is shown in FIG. 2. A first heating plate 202, a template 204 disposed on the first heating plate 202, a second heating plate 206 disposed above the template 204 and substantially parallel to the first heating plate 202, and a cavity 208 formed in a top of the template 204 are used to fabricate the hollow metallic structure. An amorphous metal 210 is deposited on the top of the template 204 over the cavity 208. The metallic glass 210 of varying initial thickness is embossed under linearly increasing load (F). The load, loading rate, and the cavity diameter (D) are varied but the processing temperature is kept constant. More specifically, the accumulated load (Q) is the area under the load-time curve. A disk of metallic glass 210 with initial radius (Rᵢ) and thickness (Hᵢ) is placed on a cylindrical cavity 208 machined in an aluminum (Al) template 204. The setup is heated above the glass transition temperature (T_{g}) of the metallic glass using two parallel heating plates 202 and 204. A time-varying load F=βt is applied (where β is the loading rate and t is the embossing time). The accumulated load (Q) is the area under the load-time curve which determines the extent of thermoplastic deformation of metallic glass [16]. The metallic glass 210 flows vertically into the template cavity 208 and laterally due to unrestrained geometry. As a result, the thickness (H) of residual metallic glass layer decreases while the radius (R) and filling length (L) increase during embossing.

The viscosity of metallic glass supercooled liquids is of the order of 10⁵-10⁹ Pa·s [15]. Hence, the previous investigations have used Stokes flow equations to describe the disk flattening and cavity filling process during embossing [16, 27]. As explained in below in the supplementary information, a simple scaling analysis relating the viscous resistance contributions at the cavity entrance and applied pressure can be formulated as

$$P \approx [ \frac{16 η L}{{D}^{2}} ] \frac{dL}{dt} + [ \frac{Π μ η {D}^{2}}{{H}^{3}} ] \frac{dL}{dt} \qquad ( 2 )$$

where μ is the lateral flow resistance coefficient and was used as a fitting parameter to match the experimental results as shown in FIG. 3. The first term in Eq. (2) corresponds to the flow resistance along the cavity length, and the second term corresponds to the lateral flow resistance (acting along the radius of the metallic glass disk). At large H (or H/D ratio) values, the second term becomes negligible and the equation reduces to Eq. (1). The second term becomes significant and starts to influence the filling process (FIGS. 1A-1I & 3) when H becomes comparable or smaller than D. For convenience of integration, consider H a time invariant (valid for samples with small thickness variation during embossing) and obtain the solution for Eq. (2) as

$$\overline{L} = - {α [ \frac{H}{D} ]}^{- 3} + {[ {{α}^{2} [ \frac{H}{D} ]}^{- 6} + 1 ]}^{1 / 2} \qquad ( 3 )$$

where \tilde{L} is the non-dimensional reduced filling length (Eq. (8) in SI), and α is a non-dimensional parameter related to lateral flow resistance μ in Eq. (2). \tilde{L} is the L/D ratio obtained by solving Eq. 2 and normalized by the maximum L/D attainable for the given loading conditions. The maximum L/D is calculated from Eq. (1). Eq. (3) can be used for any thickness while Eq. (1) is the upper bound and valid one for thick samples. FIG. 3 compares the experimental and calculated \tilde{L} (Eq. (3)) values for varying H/D ratios. The experimental values match well with the theoretical calculations and Eq. (3) captures the observed thickness dependence in filling length. The H values on the abscissa correspond to the thickness of the metallic glass measured after embossing. At all H/D values greater than 1, the observed filling length approaches the maximum filling length (i.e. \tilde{L}=1). But for H/D<1, \tilde{L} decreases with decreasing H/D indicating lesser filling for thin samples. The observed scatter in the measured \tilde{L} at small H/D values is due to the machine compliance, which affects the actual area of contact between the heated plates and the metallic glass disk, and thus the applied pressure.

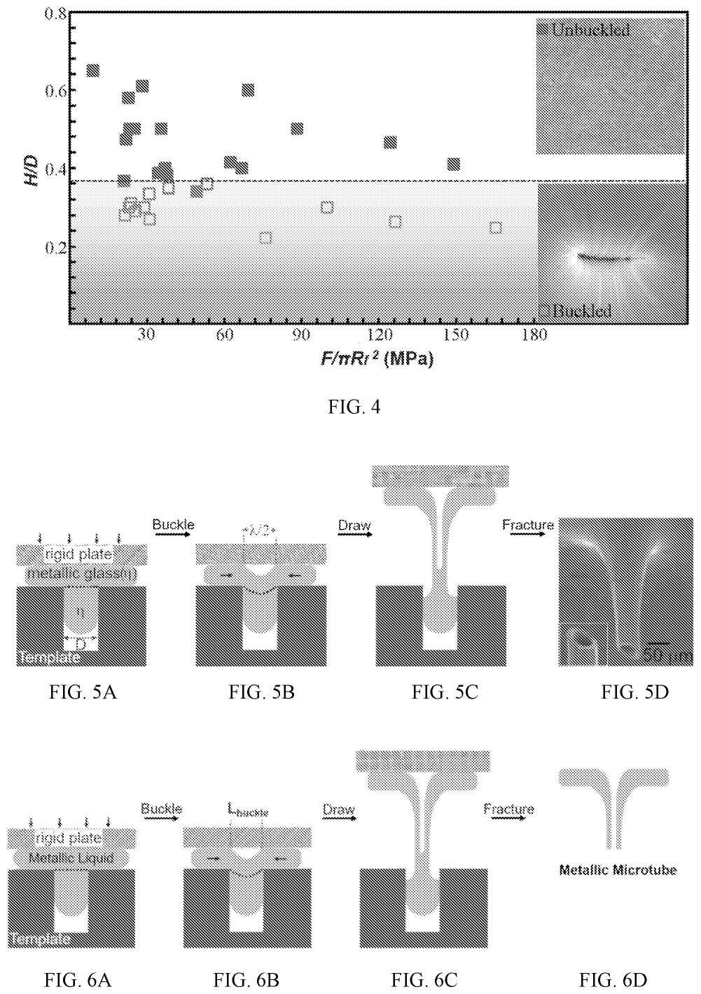

Another interesting effect of thickness is the buckling of metallic glass supercooled liquid. As shown in FIGS. 1A-1I, the thin metallic glass buckles/folds into the template cavity while the thick sample does not show such instability. Though the observed thickness (geometric parameter) dependence of buckling hints towards its viscous nature, it is important to verify the absence or presence of an elastic contribution. A series of embossing experiments were performed by varying the initial thickness, load, and embossing time. A viscous buckling should only depend on the geometric factor while an elastic buckling requires a critical stress. FIG. 4 shows a plot between the non-dimensional final thickness (H/D) and load (F) normalized by the final disk area. The two sets of data points correspond to buckled (open squares) and unbuckled (filled squares) samples. As shown in the insets, the samples with no surface deformation were labeled as unbuckled, while any observable surface feature was considered as an indication of buckling. It is evident from FIG. 4 that (i) the unbuckled-to-buckled transition occurs at a critical H/D value in the range of ˜0.36-0.4 (i.e. geometric parameters govern the buckle formation) and (ii) the critical H/D value is independent of the applied load/pressure (i.e. there is no threshold stress for initiation of buckling). These observations suggest that the observed buckling is viscous in nature and elastic effects can be ruled out.

The embossing experiments always resulted in some amount of cavity filling prior to buckling. This can be envisioned as buckling of viscous metallic glass layer embedded between a rigid plate and viscous metallic glass column as schematically shown in FIG. 5A. The thin metallic glass layer is subjected to in-plane compression due to high lateral flow resistance. The buckling of thin viscous and elastic multilayers has been studied in geological [28-31] and self-assembly [26, 32] systems. The buckling wavelength (A) can be predicted from the layer thickness and the ratios of viscosity (or elastic constant) values [29, 30]. In the current system, the presence of template cavity confines the maximum wavelength to 2D. The critical thickness corresponding to this buckling wavelength can be estimated as ˜λ/4 (=0.5D) from the model developed by Biot et al. [29] and Ramberg et al. [33]. Despite the different geometry in theoretical models, the calculated thickness (0.5D) for buckling is reasonably close to the observed value of 0.4D. Though buckling is undesirable in template imprinting, it can be harnessed in fabrication of metal microtubes (FIG. 5B). The metallic glass and the template are pulled apart after formation of a buckle on the top of solid pillar (FIG. 5C). The buckle gets elongated resulting in formation of hollow metallic structure, which is subsequently cooled and fractured at room temperature. FIG. 5D shows an SEM image of representative sample fabricated using this procedure. The proposed methodology can be applied to multiple buckles to make an array of metallic microtubes, which otherwise require complex processing steps [34]. The opening of microtubes can be controlled by tuning the buckle size. Metal microtubes are desired for applications in transdermal drug-delivery [35], microfluidics [36], and sensing [37].

In summary, this disclosure demonstrates that the template-based thermoplastic embossing of metallic glasses is sensitive to their thickness. A general flow model for all thicknesses is developed whereas the earlier models are valid only for embossing of thick metallic glasses. Significant reduction in filling length is observed when the metallic glass thickness becomes comparable or smaller than the diameter of template cavities. In this regime, the supercooled liquid undergoes buckling due to mounting lateral flow resistance. The buckling wavelength can be predicted based on the existing theories for viscous buckling of multilayer systems. In addition, the thickness dependent buckling of metallic glass can be utilized in manufacturing of hollow metal structures.

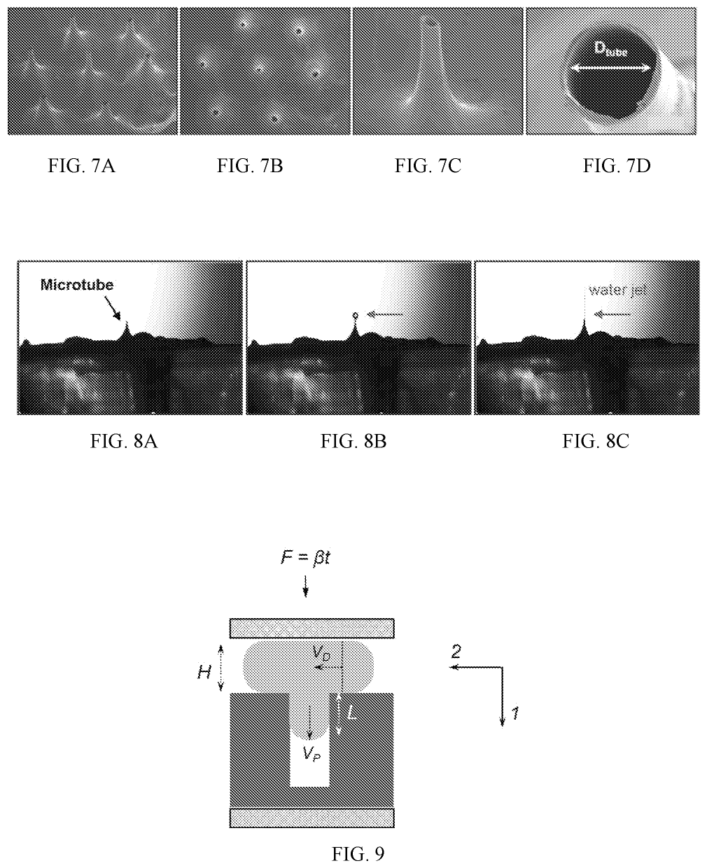

An example of the fabrication procedure is schematically illustrated in FIGS. 6A-6D. Initially, an amorphous metal disc is hot-pressed into a cavity (made by inexpensive drilling) in FIG. 6A. The flow behavior and dimensions of amorphous metal are controlled to induce a buckle on the top surface of the disc. The lateral dimension (L_{buckle} in FIG. 6B) can be controlled via thickness of the disc, diameter of the cavity, and the processing temperature. Once the buckle is formed, the metallic disc and the template are pulled apart in FIG. 6C. The buckle gets elongated resulting in formation of hollow metallic structure, which is subsequently cooled and fractured at room temperature (FIG. 6D). FIGS. 7A-7D show SEM images of representative samples fabricated using this procedure. The methodology can be applied to multiple buckles to make an array of metallic microtubes (FIGS. 7A-7B). The opening of microtubes (D_{tube} in FIG. 7D) can be controlled by tuning the buckle size. These metallic tubes are open-ended as demonstrated by flowing water through them (FIGS. 8A-8C). The amorphous metals exhibit higher yield strength and elastic strain limit which allow the tubes to withstand higher stress without buckling. However, the amorphous metal tubes can also be crystallized to form crystalline tubes if necessary.

Metal microtubes are desirable as: microneedles in transdermal drug-delivery; heat exchangers in microelectronics; micro-combustion equipment; through channels in microfluidics; and electrodes in chemical and biochemical sensors. One such example related to transdermal drug-delivery and microfluidic application is shown in FIGS. 8A-8C.

Supplemental Information

FIG. 9 shows the scenario of thermoplastic embossing of metallic glass in to a template with single central cavity heated above the glass transition temperature (T_{g}). The viscosity (η) of the Pt-based metallic glass in the super-cooled liquid state is of the order of 10⁶ Pa s.

Therefore, the previous investigations have utilized Stokes equations to describe the flow of metallic glass [16].

η [symbol] ²ν= [symbol] P, [symbol] v=0 (S1)

where ν and P are the velocity and pressure fields near the entrance of the cavity. The flow of the metallic glass under the applied load (F=βt) results in filling of the cavity (flow in direction 1) and thinning of the metallic glass disk (flow in direction 2).

Filling of Cavity:

Along the depth of the cavity, the Stokes equation (Equation 1) yields

$$\frac{η {v}_{p}}{{D}^{2}} = \frac{Δ {P}_{1}}{16 L} \qquad ( S2 )$$

where νₚ is the maximum velocity of the metallic glass front, D is the cavity diameter, ΔP₁ is the pressure difference between entrance of the pore and atmospheric pressure along direction 1, L is the instantaneous filling length.

Thinning of Disk:

Equation 1 yields

$$μ [ \frac{η {v}_{D}}{{H}^{2}} ] = \frac{Δ {P}_{2}}{D} \qquad ( S3 )$$

where ν_{D} is the maximum velocity of the metallic glass front along the disk direction, H is the instantaneous thickness of the metallic glass disk, and μ is the lateral flow resistance coefficient and was used as a fitting parameter to match the experimental results. Consider P as the total applied pressure during the thermoplastic forming process. ν_{D} can be expressed in terms of νₚ by imposing volume conversation constraint. Equation 2 and Equation 3 yields

$$P = η [ \frac{16 L}{{D}^{2}} + \frac{Π μ {D}^{2}}{{H}^{3}} ] {v}_{P} \qquad ( S4 )$$

Here ν_{P}=dL/dt

$$P = η [ \frac{16 L}{{D}^{2}} + \frac{Π μ {D}^{2}}{{H}^{3}} ] \frac{d L}{d t} \\ \frac{P d t}{η} = [ \frac{16 L}{{D}^{2}} + \frac{Π μ {D}^{2}}{{H}^{3}} ] d L$$

Integrating on both sides

$$\frac{8 {L}^{2}}{{D}^{2}} + \frac{Π μ {D}^{2}}{{H}^{3}} L = \overline{q} \qquad ( S5 )$$

where

$$\overline{q} = \frac{1}{η} \int Pdt$$

is the dimensionless total applied pressure at the end of the embossing. Rearranging and expressing the above equation as a quadratic in L/D yields

$${8 [ \frac{L}{D} ]}^{2} + {Πμ [ \frac{D}{H} ]}^{3} [ \frac{L}{D} ] - \overline{q} = 0 \qquad ( S6 )$$

Considering α′=Πμ/16, and solving for L/D yields

$$\frac{L}{D} = - {{α}^{′} [ \frac{H}{D} ]}^{- 3} + {[ {{α}^{′2} [ \frac{H}{D} ]}^{- 6} + \overline{\frac{q}{8}} ]}^{1 / 2} \qquad ( S7 )$$

Dividing throughout by

$${[ \frac{\overline{q}}{8} ]}^{1 / 2}$$

implies

$$\overline{L} = - {α [ \frac{H}{D} ]}^{- 3} + {[ {{α}^{2} [ \frac{H}{D} ]}^{- 6} + 1 ]}^{1 / 2}$$

where

$$\tilde{L} = \frac{\frac{L}{D}}{{[ \frac{\overline{q}}{8} ]}^{1 / 2}} \qquad$$

is the reduced filling length, and

$$α = \frac{{8}^{0.5} {α}^{′}}{{\overline{q}}^{1 / 2}}$$

is the reduced flow resistance term. Here,

$${\overline{q}}^{1 / 2} = {[ \frac{1}{η} \int PdT ]}^{1 / 2} .$$

As per Eq. (1), the term on the right gives normalized filling length (L/D)ₘₐₓᵢₘᵤₘ. This (L/D)ₘₐₓᵢₘᵤₘ represents maximum filling length for the given loading conditions. The lateral flow resistance coefficient μ was used as a fitting parameter to match the experimental results and the corresponding L̅ vs H/D plot is shown in FIG. 3.

### Additional Embodiments

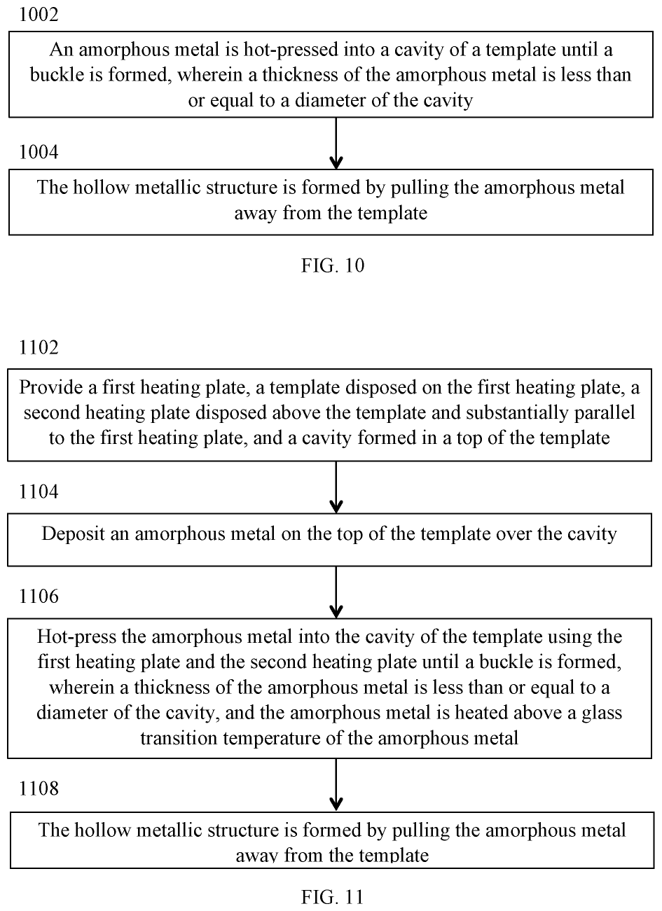

FIG. 10 is a flow chart of a method 1000 for manufacturing a hollow metallic structure in accordance with another embodiment of the present invention. An amorphous metal is hot-pressed into a cavity of a template until a buckle is formed in block 1002. A thickness of the amorphous metal is less than or equal to a diameter of the cavity. The hollow metallic structure is formed by pulling the amorphous metal away from the template in block 1004.

In one aspect, the method further comprises providing a first plate, the template disposed on the first plate, and a second plate disposed above the template and substantially parallel to the first plate. In another aspect, the first plate comprises a first heating plate, the second plate comprises a second heating plate, and the amorphous metal is heated above a glass transition temperature of the amorphous metal using the first and second heating plates. In another aspect, the method further comprises depositing the amorphous metal on a top of the template over the cavity. In another aspect, the hollow metallic structure is self-standing. In another aspect, the method further comprises forming a metallic tube by cooling and fracturing the hollow metallic structure. In another aspect, the method further comprises using the metallic tube as a needle, and heat exchanger, a through channel or an electrode. In another aspect, the method further comprises attaching the metallic tube to a substrate. In another aspect, the method further comprises crystallizing the hollow metallic structure. In another aspect, the method further comprises controlling a lateral dimension of the buckle via a thickness of the amorphous metal, a diameter of the cavity and a temperature. In another aspect, the method further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature. In another aspect, the cavity comprises two or more cavities and the hollow metallic structure is formed from each cavity. In another aspect, the two or more cavities are arranged in a pattern or an array.

FIGS. 7A-7D and 8A-8C are images of hollow metallic structures manufactured in accordance with another embodiment of the present invention. One process used to manufacture the hollow metallic structure includes hot-pressing an amorphous metal into a cavity of a template until a buckle is formed, wherein a thickness of the amorphous metal is less than or equal to a diameter of the cavity (FIG. 10A), and forming the hollow metallic structure by pulling the amorphous metal away from the template (FIG. 10B).

In one aspect, the process further comprises providing a first plate, the template disposed on the first plate, and a second plate disposed above the template and substantially parallel to the first plate. In another aspect, the first plate comprises a first heating plate, the second plate comprises a second heating plate, and the amorphous metal is heated above a glass transition temperature of the amorphous metal using the first and second heating plates. In another aspect, the process further comprises depositing the amorphous metal on a top of the template over the cavity. In another aspect, the hollow metallic structure is self-standing. In another aspect, the process further comprises forming a metallic tube by cooling and fracturing the hollow metallic structure. In another aspect, the process further comprises using the metallic tube as a needle, and heat exchanger, a through channel or an electrode. In another aspect, the process further comprises attaching the metallic tube to a substrate. In another aspect, the process further comprises crystallizing the hollow metallic structure. In another aspect, the process further comprises controlling a lateral dimension of the buckle via the thickness of the amorphous metal, the diameter of the cavity and a temperature. In another aspect, the process further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature. In another aspect, the cavity comprises two or more cavities and the hollow metallic structure is formed from each cavity. In another aspect, the two or more cavities are arranged in a pattern or an array.

FIG. 11 is a flow chart of a method for manufacturing a hollow metallic structure in accordance with another embodiment of the present invention. Now also referring to FIG. 2, a first heating plate 202, a template 204 disposed on the first heating plate 202, a second heating plate 206 disposed above the template 204 and substantially parallel to the first heating plate 202, and a cavity 208 formed in a top of the template 204 are provided in block 1102. An amorphous metal 210 is deposited on the top of the template 204 over the cavity 208 in block 1104. The amorphous metal 210 is hot-pressed into the cavity 208 of the template 204 using the first heating plate 202 and the second heating plate 206 until a buckle is formed in block 1106. A thickness of the amorphous metal 210 is less than or equal to a diameter D of the cavity 208. Moreover, the amorphous metal 210 is heated above a glass transition temperature of the amorphous metal 210. The hollow metallic structure is formed by pulling the amorphous metal 210 away from the template 204 in block 1108.

In one aspect, the hollow metallic structure is self-standing. In another aspect, the method further comprises forming a metallic tube by cooling and fracturing the hollow metallic structure. In another aspect, the method further comprises using the metallic tube as a needle, and heat exchanger, a through channel or an electrode. In another aspect, the method further comprises comprising crystallizing the hollow metallic structure. In another aspect, the method further comprises controlling a lateral dimension of the buckle via a thickness of the amorphous metal, a diameter of the cavity and a temperature. In another aspect, the method further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature. In another aspect, the cavity comprises two or more cavities and the hollow metallic structure is formed from each cavity. In another aspect, the two or more cavities are arranged in a pattern or an array.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

1. G. Kumar, H. X. Tang, and J. Schroers, Nature 457, 868 (2009).

2. M. Hasan, J. Schroers, and G. Kumar, Nano Lett. 15, 963 (2015).

3. T. Xia, N. Li, Y. Wu, and L. Liu Appl. Phys. Lett. 101, 081601 (2012).

4. B. Sarac, G. Kumar, T. Hodges, S. Ding, A. Desai, and J. Schroers J. Microelectromech. Syst. 20, 28 (2011).

5. J. Schroers, Q. Pham, A. Peker, N. Paton, and R. V. Curtis Scr. Mater. 57, 341 (2007).

6. Y. Kawamura, T. Shibata, A. Inoue, and T. Masumoto Acta Mater. 46, 253 (1998).

7. R. Martinez, G. Kumar, and J. Schroers, Scr. Mater. 59, 187 (2008).

8. X. Xiao, S. S. Fang, Q. Wang, G. M. Wang, Q. Hua, and Y. D. Dong Mater. Lett. 58, 2357 (2004).

9. M. Hasan, and G. Kumar, Nanoscale 9, 3261 (2017).

10. Z. Hu, C. S. Meduri, J. Blawzdziewicz, and G. Kumar, Nanotechnology 30, 075302 (2018).

11. R. Li, Z. Chen, A. Datye, G. H. Simon, J. Ketkaew, E. Kinser, Z. Liu, C. Zhou, O. E. Dagdeviren, S. Sohn, J. P. Singer, C. O. Osuji, J. Schroers, and U. D. Schwarz, Comms. Phys. 1, 75 (2018).

12. X. Zhang, Y. Luo, J. Li, B. Dun, S. He, S. Yan, and Q. Li, Int. J. Mach. Tool. Manu. 117, 11 (2017).

13. Z. Hu, S. Gorumlu, B. Aksak, and G. Kumar, Scr. Mater. 108, 15 (2015).

14. C. Uzun, C. Meduri, N. Kahler, L. G. de Peralta, J. M. McCollum, M. Pantoya, G. Kumar, and A. A. Bernussi, J. Appl. Phys. 125, 015102 (2019).

15. Y. Kawamura, T. Nakamura, H. Kato, H. Mano, and A. Inoue Mater. Sci. Eng. A 304, 674 (2001).

16. G. Kumar, J. Blawzdziewicz, and J. Schroers, Nanotechnology 24, 2013.

17. J. Lu, G. Ravichandran, and W.L. Johnson, Acta Mater. 51, 3429 (2003).

18. A. Reger-Leonhard, M. Heilmaier, and J. Eckert, Scr. Mater. 43, 459 (2000).

19. C. H. Lin, and R. S. Chen, J. Micromech. Microeng. 17, 1220 (2007).

20. H. D. Rowland, A. C. Sun, P. R. Schunk, and W. P. King, J. Micromech. Microeng. 15, 2414 (2005).

21. Y. Xu, F. Tsumori, T. Toyooka, H. Kotera, and H. Miura, Jpn. J. Appl. Phys. 50, 06GK11 (2011).

22. M. Ghidelli, H. Idrissi, S. Gravier, J. J. Blandin, J. P. Raskin, D. Schryvers, and T. Pardoen, Acta Mater. 131, 246 (2017).

23. C. W. Wang, P. Yiu, J. P. Chu, C. H. Shek, and C. H. Hsueh, J. Mater. Sci. 50, 2085 (2015).

24. Y. Liu, J. Padmanabhan, B. Cheung, J. Liu, Z. Chen, B. E. Scanley, D. Wesolowski, M. Pressley, C. C. Broadbridge, S. Altman, and U. D. Schwarz, Sci. Rep. 6, 26950 (2016).

25. D. C. Hyun, G. D. Moon, C. J. Park, B. S. Kim, Y. Xia, and U. Jeong, Adv. Mater. 22, 2642 (2010).

26. P. J. Yoo, K. Y. Suh, S. Y. Park, and H. H. Lee Adv. Mater. 14, 1383 (2002).

27. N. Li, W. Chen, and L. Liu, JOM 68, 1246 (2016).

28. M. A. Biot, Proc. R. Soc. Lond. A Math. Phys. Sci. 242, 444 (1957).

29. M. A. Biot, Geol. Soc. Am. Bull. 72, 1595 (1961).

30. M. A. Biot, H. Ode, and W. L. Roever, Geol. Soc. Am. Bull. 72, 1621 (1961).

31. J. H. Fink, and R. C. Fletcher, J. Volcanol. Geotherm. Res. 4, 151 (1978).

32. A. Schweikart, A. Horn, A. Böker, and A. Fery, Complex Macromolecular Systems I, 75 (2009).

33. H. Ramberg, AAPG Bull. 47, 484 (1963).

34. Z. L. Xiang, J. Q. Liu, and C. Lee, Microsyst. Nanoeng. 2 (2016)

35. H. J. Gardeniers, R. Luttge, E. J. Berenschot, M. J. De Boer, S. Y. Yeshurun, M. Hefetz, R. van't Oever, and A. van den Berg, J. Microelectromech. Syst. 12, 855 (2003).

36. D. J. Thurmer, C. Deneke, Y. Mei, and O. G. Schmidt, Appl. Phys. Lett. 89, 223507 (2006).

37. T. Kipp, H. Welsch, C. Strelow, C. Heyn, and D. Heitmann, Phys. Rev. Lett. 96, 077403 (2006).

What is claimed is:

1. A method for manufacturing a hollow metallic structure comprising:
hot-pressing an amorphous metal into a cavity of a template until a buckle is formed, wherein a thickness of the amorphous metal is less than or equal to a diameter of the cavity; and
forming the hollow metallic structure by pulling the amorphous metal away from the template.

2. The method of claim 1, further comprising providing a first plate, the template disposed on the first plate, and a second plate disposed above the template and substantially parallel to the first plate.

3. The method of claim 2, wherein the first plate comprises a first heating plate, the second plate comprises a second heating plate, and the amorphous metal is heated above a glass transition temperature of the amorphous metal using the first and second heating plates.

4. The method of claim 1, further comprising depositing the amorphous metal on a top of the template over the cavity.

5. The method of claim 1, wherein the hollow metallic structure is self-standing.

6. The method of claim 1, further comprising forming a metallic tube by cooling and fracturing the hollow metallic structure.

7. The method of claim 6, further comprising using the metallic tube as a needle, and heat exchanger, a through channel or an electrode.

8. The method of claim 6, further comprising attaching the metallic tube to a substrate.

9. The method of claim 1, further comprising crystallizing the hollow metallic structure.

10. The method of claim 1, further comprising controlling a lateral dimension of the buckle via a thickness of the amorphous metal, a diameter of the cavity and a temperature.

11. The method of claim 1, further comprising controlling a porosity, a length, a wall thickness and a tapering angle of the hollow metallic structure using one or more parameters comprising a time-varying load, a filling length, the diameter of the cavity, the thickness of the amorphous metal, a pressure or a temperature.

12. The method of claim 1, wherein the cavity comprises two or more cavities and the hollow metallic structure is formed from each cavity.

13. The method of claim 12, wherein the two or more cavities are arranged in a pattern or an array.

14. A hollow metallic structure manufactured by a process comprising:
hot-pressing an amorphous metal into a cavity of a template until a buckle is formed, wherein a thickness of the amorphous metal is less than or equal to a diameter of the cavity; and
forming the hollow metallic structure by pulling the amorphous metal away from the template.

15. The hollow metallic structure of claim 14, wherein the process further comprises providing a first plate, the template disposed on the first plate, and a second plate disposed above the template and substantially parallel to the first plate.

16. The hollow metallic structure of claim 15, wherein the first plate comprises a first heating plate, the second plate comprises a second heating plate, and the amorphous metal is heated above a glass transition temperature of the amorphous metal using the first and second heating plates.

17. The hollow metallic structure of claim 14, wherein the process further comprises depositing the amorphous metal on a top of the template over the cavity.

18. The hollow metallic structure of claim 14, wherein the hollow metallic structure is self-standing.

19. The hollow metallic structure of claim 14, wherein the process further comprises forming a metallic tube by cooling and fracturing the hollow metallic structure.

20. The hollow metallic structure of claim 19, wherein the process further comprises using the metallic tube as a needle, and heat exchanger, a through channel or an electrode.

21. The hollow metallic structure of claim 20, wherein the process further comprises attaching the metallic tube to a substrate.

22. The hollow metallic structure of claim 14, wherein the process further comprises crystallizing the hollow metallic structure.

23. The hollow metallic structure of claim 14, wherein the process further comprises controlling a lateral dimension of the buckle via the thickness of the amorphous metal, the diameter of the cavity and a temperature.

24. The hollow metallic structure of claim 14, wherein the process further comprises controlling a porosity, a length, a wall thickness and a tapering angle of the hollow metallic structure using one or more parameters comprising a time-varying load, a filling length, the diameter of the cavity, the thickness of the amorphous metal, a pressure or a temperature.

25. The hollow metallic structure of claim 14, wherein the cavity comprises two or more cavities and the hollow metallic structure is formed from each cavity.

26. The hollow metallic structure of claim 25, wherein the two or more cavities are arranged in a pattern or an array.

27. A method for manufacturing a hollow metallic structure comprising:
providing a first heating plate, a template disposed on the first heating plate, a second heating plate disposed above the template and substantially parallel to the first heating plate, and a cavity formed in a top of the template;
depositing an amorphous metal on the top of the template over the cavity;
hot-pressing the amorphous metal into the cavity of the template using the first heating plate and the second heating plate until a buckle is formed, wherein a thickness of the amorphous metal is less than or equal to a diameter of the cavity and the amorphous metal is heated above a glass transition temperature of the amorphous metal; and
forming the hollow metallic structure by pulling the amorphous metal away from the template.

28. The method of claim 27, wherein the hollow metallic structure is self-standing.

29. The method of claim 27, further comprising forming a metallic tube by cooling and fracturing the hollow metallic structure.

30. The method of claim 29, further comprising using the metallic tube as a needle, and heat exchanger, a through channel or an electrode.

31. The method of claim 27, further comprising crystallizing the hollow metallic structure.

32. The method of claim 27, further comprising controlling a lateral dimension of the buckle via a thickness of the amorphous metal, a diameter of the cavity and a temperature.

33. The method of claim 27, further comprising controlling a porosity, a length, a wall thickness and a tapering angle of the hollow metallic structure using one or more parameters comprising a time-varying load, a filling length, the diameter of the cavity, the thickness of the amorphous metal, a pressure or a temperature.

34. The method of claim 27, wherein the cavity comprises two or more cavities and the hollow metallic structure is formed from each cavity.

35. The method of claim 34, wherein the two or more cavities are arranged in a pattern or an array.
